(19) United States
(12) Patent Application Publication
(10) Pub. No.: US 2008/0091445 A1
(43) Pub. Date: Apr. 17, 2008

(54) METHOD AND SYSTEM FOR DYNAMIC SOCIAL NETWORKING BASED ON SIMILAR TRAVEL ITINERARIES

(76) Inventor: Matthew Mihic, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/549,961

(22) Filed: Oct. 16, 2006

(51) Int. Cl. G06Q 10/00; G06Q 30/00

(52) U.S. Cl. 705/1; 705/5

(57) ABSTRACT

In one embodiment, a method that can be performed on a system, is provided for dynamic social networking based on similar travel itineraries. In one embodiment, the method comprises identifying a set of travel options selected in relation to a travel itinerary of a first traveler; searching a set of travel options previously reserved for travel itineraries of separate additional travelers, to determine if one or more of the travel options selected by the first traveler match one or more of the travel options selected by one or more of the separate additional travelers, based on a predetermined matching criteria; and in response to identifying a match between one or more of the travel options selected by the first traveler and one or more travel options selected by one of the separate additional travelers, sending an invitation for a meeting between the first traveler and one or more of the additional travelers.

### CROSS-REFERENCE TO RELATED APPLICATIONS

This application is related to U.S. patent application Ser. No. 11/112,376, Filed Apr. 21, 2005, entitled, “Aggregate Collection Of Travel Data”, U.S. patent application Ser. No. 11/178,007, filed Jul. 31, 2005, entitled, “System for Travel Services Resource U.S. patent application Ser. No. 11/240,739, Filed Sep. 30, 2005, entitled “Method And System For Capturing And Calculating Complex Consumer Ratings Of Goods And Services” and U.S. patent application Ser. No. 11/240,740, filed Sep. 30, 2005 entitled: “Method And System For Testing Of Policies To Determine Cost Savings”, all of which are incorporated herein by reference.

### BACKGROUND OF THE INVENTION

People often make travel bookings according to a pre-determined set of rules, or according to their accustomed travel arrangements. However, certain types of bookings may often result in costly changes at the last minute. It may be that booking different types travel arrangements, for example, in a different travel class with no change penalty, may be a wiser choice for certain bookings, such as, for example, bookings for travel and accommodations for a convention or for a customer meeting that may often require last-minute changes.

What is clearly needed is a system, method and apparatus for tracking booking behavior patterns of travelers, and, based on historical aggregate data and internal and external events, for suggesting better booking methods for initial bookings, resulting in a lower average over-all cost.

Often people travel to the same destination or use the same accommodations repeatedly, and they may notice other people who also make the same trip or use the same accommodations repeatedly. However, there is no good way for a person to meet these other travelers and the person is also concerned about doing so without previously knowing something about the person or persons he would like to meet.

What is clearly needed is a system, method, and apparatus that allows unacquainted travelers who travel the same routes or use the same facilities or services, etc. to enter into a social network in a controlled manner.

### SUMMARY

In one embodiment, a method that can be performed on a system, is provided for dynamic social networking based on similar travel itineraries. In one embodiment, the method comprises identifying a set of travel options selected in relation to a travel itinerary of a first traveler; searching a set of travel options previously reserved for travel itineraries of separate additional travelers, to determine if one or more of the travel options selected by the first traveler match one or more of the travel options selected by one or more of the separate additional travelers, based on a predetermined matching criteria; and in response to identifying a match between one or more of the travel options selected by the first traveler and one or more travel options selected by one of the separate additional travelers, sending an invitation for a meeting between the first traveler and one or more of the additional travelers.

### BRIEF DESCRIPTION OF FIGURES

FIG. 1 shows an overview of a system according to one embodiment;

FIG. 2 shows an exemplary process for implementation of the system according to one embodiment; and

FIG. 3 shows an exemplary process for implementation of the system according to one embodiment of the present invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

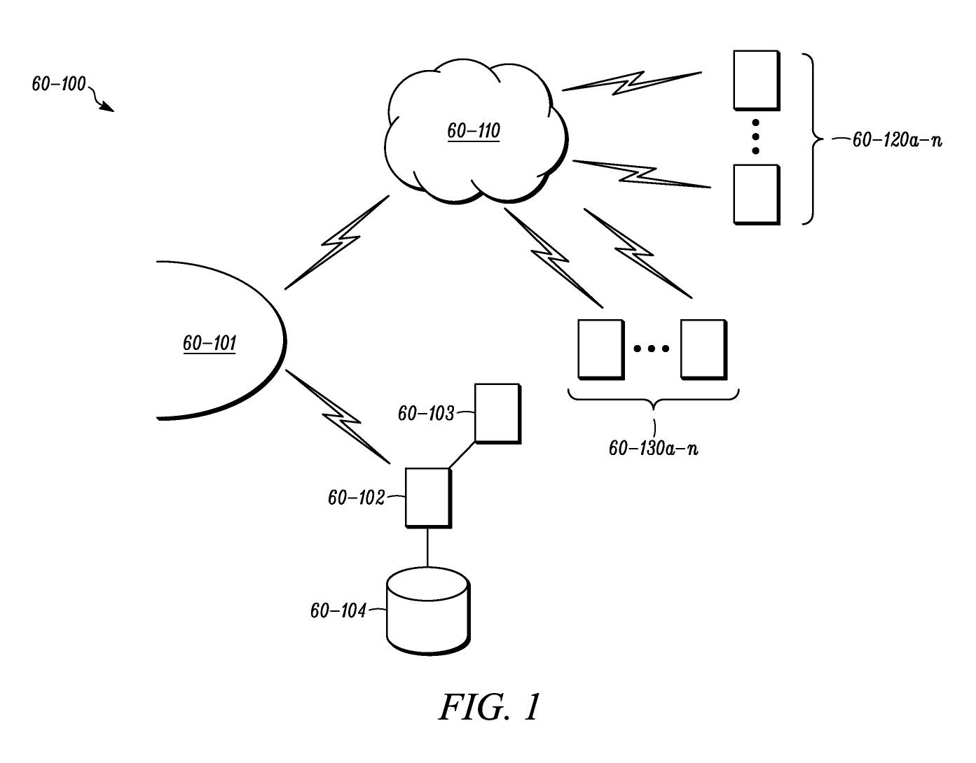

FIG. 1 shows an overview of a system 100 according to the present invention. An electronic services system 101 has a server 102 that hosts a software instance 103 and has access to a data repository or database 104. It is clear that this simplified depiction shows only elements of interest pertaining to the present invention, and that all these elements may be part of a much larger system. Also shown is a connection of electronic services system 101 to the Internet 110, to which users 130 a-n and vendors 120 a-n are also connected. It is clear that in some cases the users and/or vendors may be connected to services system 101 directly, or through a private network or VPN or some other type of network connection without departing from the spirit of the invention.

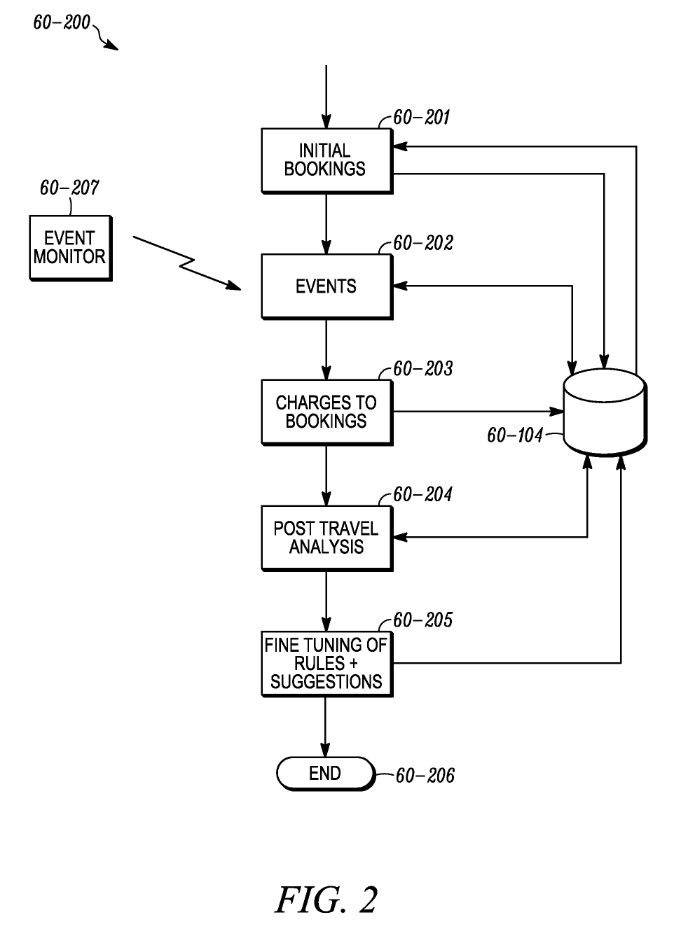

FIG. 2 shows an exemplary process 200 for implementation of the system according to one embodiment of the present invention. In step 201 a user makes an initial booking, in some cases based on recommendations by the system, which recommendations are stored in database 104. It will be discussed later how these recommendations are generated, but in essence they are based on the rules that apply for this individual user, with some variations as discussed below. In step 202, an event monitor 207 monitors events relevant to the traveler's plans, including events in the traveler's own agenda and schedules within his company, external events along his travel route and at his accommodations (in all the cities and countries that are included in the travel route), and also events at partner companies that he is visiting. Based on those events, in step 203, the user may need to make changes in his bookings. The correlation between the changes and the monitored events are stored in database 104, as well as the changes themselves.

After the traveler returns from his trip, in step 204, the system does a post-travel analysis to determine whether some of the penalties and fees invoked by travel changes could have been avoided or lowered had different types of bookings been made. These analysis results are also stored in database 104. In step 205, the system makes a fine-tuning of rules and suggestions, based on the historic aggregate of relevant travels of both this user and other users who followed the same route, and in step 206, the process ends. For example, a large event at a target location may have led to cancellations or changes in hotel reservations or overbooking of flights, and therefore to unacceptable delays or problems in users' travel plans. Thus the system may determine that the traveler should have initially purchased an unrestricted ticket, allowing him to avoid change penalties, etc.

In some cases, a novel aspect of the software system includes attributes for a trip that the electronic services system would look at for both new and historical trips. Some example attributes of a trip could include the following: reason for trip (e.g., sales call, maintenance call, industry conference, internal meeting, etc.), specific parties involved in the trip (e.g., customer A, internal colleague B, industry conference C, etc.), specific location (e.g., a given city, convention center, or a property of a city such as being a European city or an Asian city), timing (e.g., time of year, the fact that the trip is on a Monday or Friday, proximity to a major holiday, etc.), proximity to other activities on a user's calendar (e.g., do other meetings in different cities tightly adjacent introduce additional travel change risk, do tentative, conflicting meetings on the user's calendar make a change more likely), user-defined priority of the event (e.g., the user could state that this is a Tier 1 customer or a Tier 2 customer, which could inform whether the trip is likely to change), and other attributes of the trip, both defined by the user and derived from the attributes of the proposed and past trips.

Additionally, in yet other cases, the system could offer a display of the same booking with different rate/restriction combinations. For example, a hotel room may be available at a given hotel with three options. Option A might have a large penalty for change and a pre-payment requirement, option B might have only a penalty if not cancelled 24 hours ahead, but a higher per night rate, and option C might have a slightly higher rate, but include amenities such as parking, breakfast, and Internet access. In these cases, a novel part of the system would be a display that shows a specific hotel with multiple booking options all in a tightly integrated display.

### Dynamic Social Networking Based on Similar Travel Itineraries

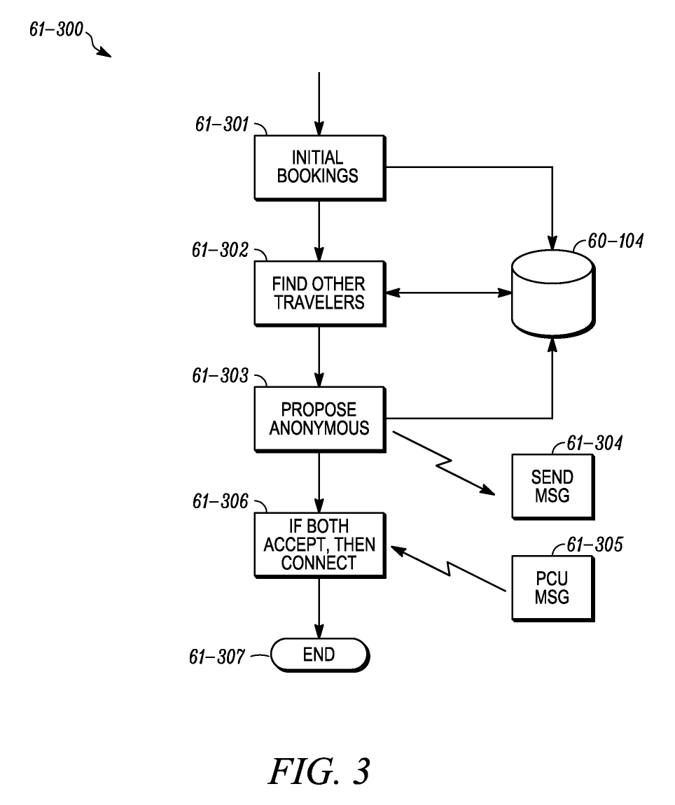

FIG. 3 shows an exemplary process 300 for implementation of the system according to one embodiment of the present invention. In step 301, the system makes a travel booking and stores the booking information in database 104. In step 302, the system searches database 104 to find other travelers who have the same bookings for some or all of the itinerary. In some cases, the system may also search other available data from other sources. In step 303, the system asks the original traveler if he wants to send out an anonymous proposal to meet via function 304 to another traveler to meet at a mutual itinerary point. Unlike “chance meetings”, meetings could be arranged between total strangers, of unrelated companies, if so desired.

In some cases, as part of the anonymous proposal program, for example, the company may have certain rules about their employees meeting with employees from certain other companies (such as competitors or adversaries). Thus a traveler could specify that he does not want to meet other travelers from company XYZ, or he could submit a list of individuals he does not wish to meet, for whatever reason. Any response is received via function 305. Then in step 306, if both travelers accept the proposal, they may make a connection. The process ends at step 307. In some cases, in case of a rejection, the reason for the rejection would not be disclosed, or even the fact of a rejection. Rather, the system would respond with a laconic, non-disclosing “no match found” type of message.

In one embodiment, a user identifies who the user wants to meet via a “buddy list” concept similar to a network a user has in an IM system. In the embodiment, the system also allows the end user to put in attributes describing the types of people they would be interested in meeting. Some example attributes could include companies in an explicit list, companies with which the user's company has a relationship (e.g. customers of my company, suppliers to my company). Other example attributes could include the position or role of the person (a user could be interested in other engineers, other marketing people, etc.).

In one embodiment, the system also allows the user to define when they want to meet. Some examples of more instructions on when include time ranges such as “evenings.” In one embodiment, the timing is dependent on other information fed into the system via a calendar.

For example the user can identify any time that their calendar shows as free is potentially open to a meeting. The user could also define an explicit prioritization of times. For example, the user could state that their top priority time would be during the lunch hour, followed by a second priority being during the dinner hour, followed by other times that are free as a third priority.

In one embodiment, the system could also allow the user to input preferences on the type of activity that they would like to invite others to join. For example, they might input that they would prefer to share a meal or attend an event with others. Within the category of events, they would rank the types of events they would like to find people to invite. For example, a user might rank Yankee games as their top priority, baseball games in general as their second priority, and sporting events as their third priority.

It is clear that many modifications and variations of this embodiment may be made by one skilled in the art without departing from the spirit of the novel art of this disclosure.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

What is claimed is:

1) A method comprising:
identifying a set of travel options selected in relation to a travel itinerary of a first traveler;
Searching a set of travel options previously reserved for travel itineraries of separate additional travelers, to determine if one or more of the travel options selected by the first traveler match one or more of the travel options selected by one or more of the separate additional travelers, based on a predetermined matching criteria; and
In response to identifying a match between one or more of the travel options selected by the first traveler and one or more travel options selected by one of the separate additional travelers, sending an invitation for a meeting between the first traveler and one or more of the additional travelers.

2) The method of claim 1, wherein prior to sending the invitation, prompting whether the first traveler chooses to have the invitation sent.

3) The method of claim 2, wherein the one or more additional travelers are anonymous to the first traveler.

4) The method of claim 2, wherein the first traveler is anonymous to the one or more additional travelers.

5) The method of claim 1, wherein the predetermined matching criteria includes a set of rules excluding pre-identified persons from receiving invitations to meet with the first traveler.

6) The method of claim 1, wherein the predetermined matching criteria includes a set of rules excluding persons identified as related to a pre-identified entity, from receiving invitations to meet with the first traveler.

7) The method of claim 1, wherein the meeting of the invitation, is to occur relation an identified match between one or more of the travel options selected by the first traveler and one or more travel options selected by one of the additional travelers.

8) The method of claim 1, wherein the sending of the invitation includes sending the invitation to at least one of the additional travelers and receiving an acceptance to the invitation prior to sending the invitation the first traveler.

9) The method of claim 1, wherein the sending of the invitation includes sending the invitation to the first traveler and receiving an acceptance to the invitation prior to sending the invitation to least one of the additional travelers.

10) The method of claim 8, wherein in response to receiving a decline of the invitation, presenting to the first traveler a message of no match was identified.

11) A machine readable medium having stored thereon a set of instructions which when executed perform a method comprising:
identifying a set of travel options selected in relation to a travel itinerary of a first traveler;
Searching a set of travel options previously reserved for travel itineraries of separate additional travelers, to determine if one or more of the travel options selected by the first traveler match one or more of the travel options selected by one or more of the separate additional travelers, based on a predetermined matching criteria; and
In response to identifying a match between one or more of the travel options selected by the first traveler and one or more travel options selected by one of the separate additional travelers, sending an invitation for a meeting between the first traveler and one or more of the additional travelers.

12) The machine readable medium of claim 11, wherein prior to sending the invitation, prompting whether the first traveler chooses to have the invitation sent.

13) The machine readable medium of claim 12, wherein the one or more additional travelers are anonymous to the first traveler.

14) The machine readable medium of claim 12, wherein the first traveler is anonymous to the one or more additional travelers.

15) The machine readable medium of claim 11, wherein the predetermined matching criteria includes a set of rules excluding pre-identified persons from receiving invitations to meet with the first traveler.

16) The machine readable medium of claim 11, wherein the predetermined matching criteria includes a set of rules excluding persons identified as related to a pre-identified entity, from receiving invitations to meet with the first traveler.

17) The machine readable medium of claim 11, wherein the meeting of the invitation, is to occur relation an identified match between one or more of the travel options selected by the first traveler and one or more travel options selected by one of the additional travelers.

18) The machine readable medium of claim 11, wherein the sending of the invitation includes sending the invitation to at least one of the additional travelers and receiving an acceptance to the invitation prior to sending the invitation the first traveler.

19) The machine readable medium of claim 11, wherein the sending of the invitation includes sending the invitation to the first traveler and receiving an acceptance to the invitation prior to sending the invitation to least one of the additional travelers.

20) The machine readable medium of claim 18, wherein in response to receiving a decline of the invitation, presenting to the first traveler a message of no match was identified.
